(19) United States
(12) Patent Application Publication
(10) Pub. No.: US 2026/0070254 A1
(43) Pub. Date: Mar. 12, 2026

(54) APPARATUS FOR PRESERVING WOOD STRUCTURES

(71) Applicant: Steven Harris Suntup, Newton, NC (US)

(72) Inventor: Steven Harris Suntup, Newton, NC (US)

(21) Appl. No.: 18/882,849

(22) Filed: Sep. 12, 2024

(51) Int. Cl. B27K 3/02; B27K 3/48

(52) U.S. Cl. CPC B27K 3/0235; B27K 3/48

(57) ABSTRACT

A wood structure such as a post (36) is preserved by providing a reservoir (9) filled with oil (34) and allowing the oil to dran from the reservoir (9) under gravity through a spout (16) to penetrate the post (36) from inside and saturate the wood of the post (9) with the oil (34).

### FIELD OF THE INVENTION

The present invention relates to apparatus for preventing deterioration in wood structures, such as wooden fence posts. The invention is particularly intended to protect buried wood or partly buried wood, that is partly buried in soil or concrete.

Use of the terms “lumber”, “timber” and “wood” vary worldwide and the term “wood” is used herein to include all three these terms.

### BACKGROUND

Wood is a common building material used in many structures worldwide. Typically, the wood is installed on the inside of large structures where it is protected, kept dry and can last for many years, such as roof beams. However, there are instances where wooden structures are installed in areas where the wood is constantly exposed to moisture, such as wooden fence and deck posts buried partly in soil or concrete. It is a well-known fact that wood does not hold up well in moist environments and prolonged exposure to these conditions can cause the wood to rot or deteriorate over time, especially at the area where the wood meets the soil being the most vunerable to rot.

Rot occurs when the wood is continuously or periodically exposed to moisture and oxygen. These conditions are typically only present in the first few inches above and below the soil, as little to no oxygen is found deeper in the soil. When the moisture content in the wood is above the point of fiber saturation and the wood is exposed to enough oxygen, it creates an ideal environment for fungal growth. Some fungi can thrive in lower moisture contents, but still require moisture for spores to germinate and require oxygen. These fungi typically feed on plant materials, such as wood, and the fungi slowly break down the cellular structure of the plants or wood on which they feed. This can compromise the structural integrity of the wood and can cause premature structural failure. There are, however, various methods to prevent or slow down the rotting process, such as applying chemical treatments to the wood before installation and fitting protective sleeves around the wood—typically below and slightly above the soil surface.

Using a wood species that is more rot-resistant, such as Cedar, some Firs or tropical hardwoods can considerably reduce the rate of decay but these woods do not prevent rotting. Similarly, pressure treating the wood. Applying oils and commercial preservatives containing antifungal chemicals, to the surface of wood will only protect the outer layer of the wood. These preservatives need to be re-applied every few years to prevent rotting effectively (which is not practical for partially buried structures), and these chemicals can also seep into and contaminate the surrounding soil.

More recently, special polythene sleeves with a meltable bituminous inner liners, known as Postsaver®, have been used to create an air and watertight seal around a wooden post. These sleeves are commonly used with chemical preservatives to prevent rotting. A layer of chemical preservatives is applied to the wood, after which the sleeve is applied to the post using heat. The sleeve then acts as a barrier between the wood and the soil to keep the preservatives from seeping out of the wood and it prevents moisture and microorganisms in the soil from entering the wood and causing rot.

The Postsaver® liners are manufactured and cut into predetermined sizes, specifically for application to the lower sections of smaller wood structures such as fence posts. These sleeves are only applied to the sides of a small section of a fence post that will be buried in soil. This does not prevent water ingress from the bottom of the post and thus cannot effectively and fully prevent rot. This product is costly and additionally does not guarantee that the harmful chemicals applied to the wood or present in the sleeve will seep into the surrounding soil.

A similarly deficient product is available under the name Post Protector™ and comprises standard-sized plastic sheaths that are fitted around the lower ends of wooden posts to be buried. They prevent contact between the wood and soil, but do not prevent water ingress and are thus not effective if microorganisms are present inside the sheathes—e.g. if spores are carried into a sheath with rainwater. These sheathes are also costly.

Another product that does not prevent rot, but seeks to remediate rotten posts, is available under the name “Post Doctor” and comprises a casing that surrounds a post on three sides just above ground level. The casing is attached to the post with fasteners and has protuberances that extend downwards and can be embedded in concrete. The casing serves as external reinforcement for a post that has been weakened by rot. This product seeks to solve the problem of rotting posts by reinforcing them, rather than preventing rot.

The present invention seeks to address the shortfalls of the current wood preservation and rot prevention technologies. In particular, the invention seeks to provide a simple and cost-effective means for preserving wood structures that are exposed to moisture rich environments, above and below ground. The present invention also seeks to prevent or delay rotting and decay in wood structures, without the use of harsh chemicals as it uses natural oils.

### SUMMARY OF THE INVENTION

According to a first aspect of the present invention there is provided a device for preserving a wood structure, said device comprising:
a reservoir defining an internal cavity and an inlet opening in flow communication with the internal cavity, said reservoir being configured to be used in an upright orientation;
support means for supporting the reservoir adjacent to the wood structure;
at least one discharge conduit extending from the reservoir, said discharge conduit being in flow communication with the internal cavity and being at a lower elevation than the inlet opening when the reservoir is in the upright orientation, at least part of said discharge conduit being receivable in a passage opening of a passage formed in the wood structure, for flow communication between the discharge conduit and the passage opening; and
sealing means for sealing between an outer periphery of the discharge conduit and the passage opening.

Use of the indefinite article “a” and “an” in “an internal cavity”, “an inlet opening”, “a discharge conduit”, does not restrict the invention to devices which include only one of each or any of these features and the invention also includes devices with more than one cavity, more than one inlet opening and/or more than one discharge conduit.

The term “wood structure” refers herein to any structure or part thereof constructed at least partly of wood.

The term “adjacent” refers herein to the position of the reservoir relative to the wood structure, which includes the reservoir being positioned or attached inside, directly outside or close by the wood structure.

The term “upright” refers herein to the orientation of the reservoir when correctly installed and does not refer to or limit the shape of the reservoir.

The sealing means may be an O-ring and/or a rubber washer, but could be a sealant that should be applied around the hole drilled into the wood around the discharge conduit to prevent leakage, a tight fit between the periphery of the discharge conduit and the passage opening, or the like.

The device may include a closure mechanism configured to close the inlet opening selectively, such as a removable plug.

The device may define a vent aperture in flow communication with the internal cavity, said vent aperture being at a higher elevation than the discharge conduit. The device may include an overhang that extends above the vent aperture when the reservoir is in the upright orientation, to prevent debris or rain water from entering the cavity through the vent aperture.

The device may include a protective liquid in the internal cavity and the protective liquid may contain oil.

According to another aspect of the present invention there is provided a method for preserving a wood structure, said method comprising:
forming a passage inside the wood structure, said passage having a passage opening on an outer surface of the wood structure
supporting a reservoir adjacent to the wood structure, said reservoir defining an inlet opening, an internal cavity, and a discharge conduit, and said inlet opening, internal cavity and discharge conduit being in fluid communication, said receiving opening being at a higher elevation that the discharge conduit when the reservoir is in an upright orientation; connecting the discharge conduit of the reservoir to the passage opening formed in the wood structure, for fluid communication between said discharge conduit and passage opening; filling the internal cavity at least in part with the protective liquid, from the inlet opening; and allowing the protective liquid to flow down into the wood with gravity from the internal cavity, via the discharge conduit and the passage opening into the passage inside the wood structure.

The method allows the protective liquid to penetrate down into the wood structure by means of gravity.

The method may include sealing the connection between the discharge conduit of the reservoir and the passage opening formed in the wood structure, e.g. by fitting an O-ring or rubber washer around a periphery of the discharge conduit.

The method may include supporting the reservoir near a base of the wood structure, preferably about 6 inches above the ground, and may include attaching the reservoir to the wood structure using fasteners in holes provided on the reservoir.

The method may include closing the inlet opening selectively with a removable plug and may include allowing air to escape from the internal cavity through a vent aperture when the inlet opening is closed, to prevent forming a vacuum in the reservoir.

### BRIEF DESCRIPTION OF THE DRAWINGS

For a better understanding of the present invention, and to show how it may be carried into effect, the invention will now be described by way of a non-limiting example, with reference to the accompanying drawings, in which:

FIG. 1 shows an isometric front view of a preferred embodiment of a device according to the invention;

FIG. 2 shows an isometric back view of the device of FIG. 1;

FIG. 3 shows a sectional side view of the device of FIG. 1 installed in a wood structure; and

FIG. 4 shows a diagrammatic representation of a second embodiment of a device according to the invention installed on a wood structure, using the same principles as the device of FIG. 1 of gravity feed, but fitted at the top off the post to feed downwards (whereas the unit in FIGS. 1 to 3 is specific to the base of the post.

### DETAILED DESCRIPTION OF THE DRAWINGS

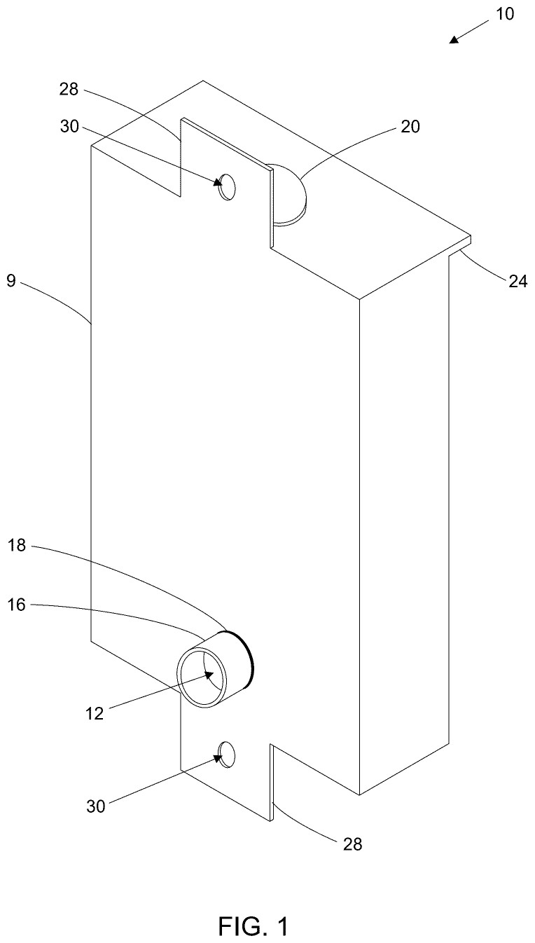

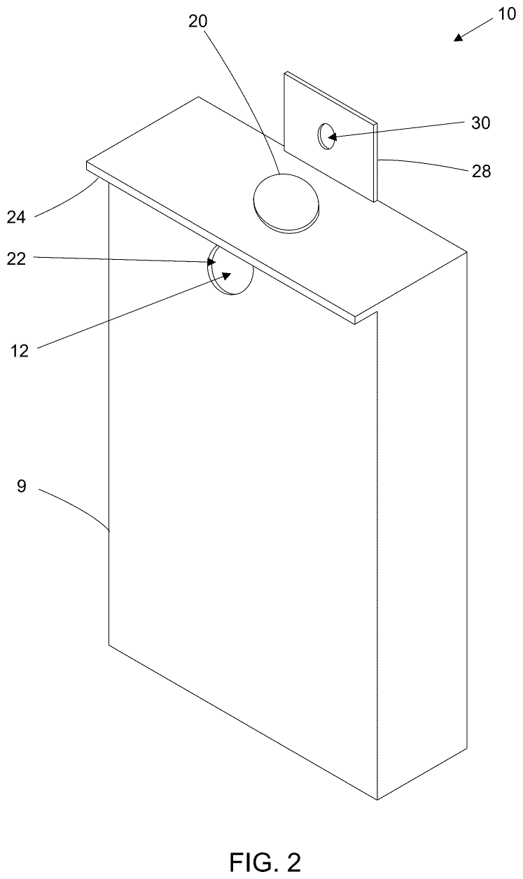

Referring to FIGS. 1 to 3, a preferred embodiment of a device for preserving wood structures according to the present invention is identified generally by the reference sign 10.

The device 10 includes a reservoir 9 with an internal cavity 12, an inlet opening 14 and a discharge conduit in the form of a spout 16 which is at a lower elevation than the inlet opening when the device is installed in an upright orientation. Both the inlet opening 14 and the spout 16 are in flow communication with the internal cavity 12 of the reservoir 9.

The reservoir 9 can be shaped differently and in the preferred embodiment shown in FIGS. 1 to 3, it is shaped to be made from sheet metal, (or die cast aluminum, or injection moulded plastic with a narrow profile that does not protrude excessively from a structure to which it is fitted. However, in other embodiments the reservoir 9 can be made of different materials, e.g. it can be molded from a suitably durable polymer and it can be shaped to suit user's preferences.

Further, the device 10 includes a single reservoir 9 with a single cavity 12, a single inlet opening 14 and a single spout 16. However, in other embodiments of the invention, a device could include multiple reservoirs (e.g. to house different protective liquids), a reservoir could be divided to include multiple cavities, the device could have multiple inlet openings (e.g. to fit different liquid dispensers), or there could be multiple spouts or other discharge conduits (e.g. to supply liquid to multiple structures or positions).

The inlet opening 14 is preferably located at the top of the reservoir 9 so that it is easily accessible when the reservoir needs to be filled with a protective liquid, such as oil 34 or other wood preservatives, after installation. The inlet opening 14 is a round aperture in a top wall of the reservoir 9, but in other embodiments of the invention, the inlet opening could be configured differently, e.g. it could include a neck with external or internal screw thread on which a cap is receivable, it could include a nipple onto which a liquid dispensing system can be fitted, it could define a receiving formation for a spout, have an automatic closure such as a flexible flap, or the like.

The spout 16 is preferably located at the bottom of the reservoir 9 or in a lower region on a side of the reservoir 9. The spout 16 is a short, cylindrical metal tube that protrudes sideways from the reservoir 9, but the device 10 could use a different form of discharge outlet, e.g. the outlet could be a flexible tube, or could have a different shape. However, the fact that the spout 16 is sturdy and extends laterally from the reservoir 9 allows it to be installed quickly and easily on a wood structure and the fact that the spout is cylindrical allows it to be installed easily in cylindrical cavities.

The device 10 further includes support means in the form of two flanges 28 extending from both the top and bottom of the reservoir 9 and each flange defines a fixing aperture 30 for supporting the reservoir adjacent to, but preferably fixed to a wood structure such as a wooden post 36. The device 10 can be installed using different support means, but it should be supported near or preferably on the post 36 and it is preferable to attach it to the post. The support means for supporting the device 10 could include strapping the device to a post with cable ties or the like, adhesive attachment, attaching the device to a bracket or other structure (such as attaching it to the underside of a crossbar or deck), but in the preferred embodiment, the device is attached to the post by fasteners such as screws that pass through the fixing apertures 30 and extend into the post 36.

The inlet opening 14 is preferably closed to prevent debris from entering the cavity 12 and contaminating the oil 34. A closing mechanism may be selected from a plug, a screw cap, pivoting cover, or the like, however, a removable, flexible plug 20 is preferred and generally supplied with the unit.

A vent aperture 22 is defined in the reservoir 9, near its top, and the vent aperture is in flow communication with the cavity 12. Such a vent aperture 22 is required when the inlet opening 14 is closed with an air-tight plug 20, to allow air to escape from the cavity 12 as the oil 34 drains from the cavity, to prevent creating a vacuum. The vent aperture 22 holds the added advantage of serving as an overflow, which indicates to a user that the cavity 12 is filled sufficiently when oil reaches the level of the vent aperture and flows out of the cavity, through the vent aperture. An overhang 24 extends above the vent aperture 22 from the top of the reservoir 9 to prevent rain, debris, etc. from entering the reservoir through the vent aperture 22.

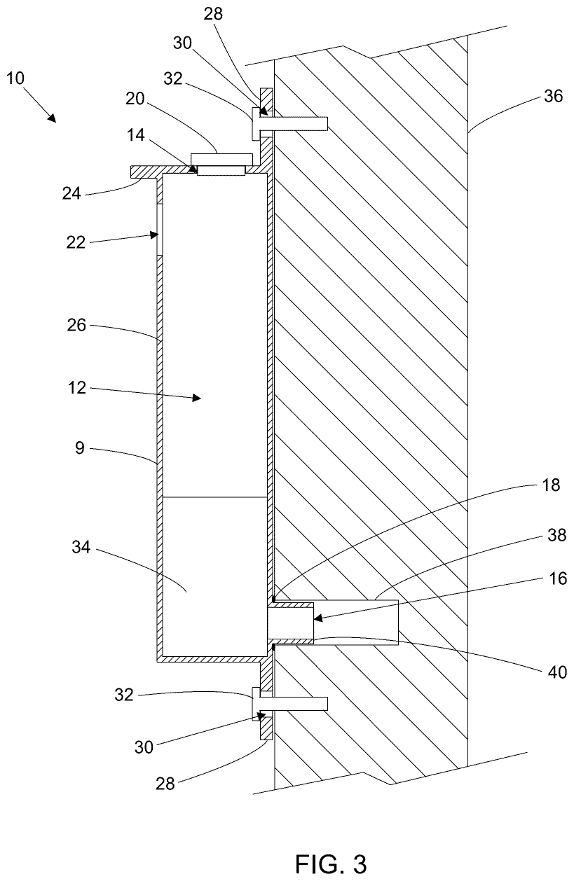

FIG. 3 shows a sectional side view of the device 10 installed on a wood structure in the form of a post 36. The post 36 is partially buried in soil (not shown in the drawings) and the device 10 is installed on the post preferably about 6 inches above ground level.

The device 10 is installed by drilling a hole horizontally into the post 36, to form a passage opening 38 in the wood, the hole being the same size as the spout 16 for a tight fit. Other techniques could be used instead, e.g. a passage opening may be punched into a wood structure, a wood structure may be formed with a passage opening, or the like. The hole can be drilled at a different angle, although in the illustrated embodiment of the invention, it should be drilled as close as possible to horizontal, into the vertical post 36. A suitable drill bit designed for wood (and not steel) is used when drilling the hole at a slow speed to preven burning or burnishing and heat sealing the wood, which could prevent seepage and penetration of oil into the wood under gravity. If necessary, the inside of the passage opening 38 can also be roughened up with a round file or round wire brush to remove burnishing and improve penetrability of the wood surface. The drill bit is selected with a size so that the passage opening 38 has a diameter into which the spout 16 fits with little to no space remaining between the passage opening walls 40 and the periphery of the spout. Sealing means in the form of an O-ring or rubber washer 18 is placed around the spout 16 to seal between the spout and the passage opening 38 when the device 10 is fixed to the post 36 to prevent the oil 34 from escaping the passage opening. Other sealing means can also be kalked around the passage opening 38 on the wooden post 36 to seal between the passage opening 38 and the periphery of the spout 16, prior to fixing, such as applying a sealant (e.g. silicone sealant), using a tight fit between the spout 16 and walls 40, or the like.

The device 10 is then fitted in the upright orientation with the spout 16 extending into the passage opening 38, ensuring that the O-ring or rubber washer 18 is flush against the post 36 to create a seal and the inlet opening 14 is located at the top of the reservoir 9 as shown in FIG. 3. The device 10 is then fixed to the outside of a wood structure 36 by fitting fasteners 32, such as screws, through the fixing apertures 30.

The plug 20 is removed to pour oil 34 into the internal cavity 12 through the inlet opening 14. Any quantity of oil 34 can be poured into the cavity 12, but as a simple, practical guide, oil can be poured until excess oil flows from the vent aperture 22. After filling the cavity 12 with sufficient oil 34, the plug 20 is fitted back into the inlet opening 14 to prevent contamination of the oil 34 inside the reservoir 9.

The oil 34 enters the passage opening 38 through the spout 16 under gravity and seeps into the porous wood of the post 36 under gravity, but also under capillary action. The oil 34 saturates a dry section of the post 36 below the spout 16 and typically also some of the wood above the spout, to preserve the wood when exposed to moisture and oxygen. Iif the post 36 is wet, the oil 34 will not penetrate into the wet section and once and the wet section dries, then the oil will fill the dried section. If the wood has a section which remains wet, the oil 34 will meet the water at the periphery of the wet section keeping oxygen out and protecting the wood. Decomposition of wood rot in permantly submerged water is rare and slow compared to wood that is frequently wet and dry, like the base of the post 34 where it meets the ground. Frequent changes between wet and dry conditions in the wood allowins ample oxygen into the wood and opens the door to rot.

In other embodiments of the present invention, the device 10 can also be installed inside or close by the post 36. In the event that the device 10 is not installed inside or directly outside the post 36, the spout 16 may be extended to reach the post 36. A pumping system could also be fitted to the device 10 to provide pressure to dispense the oil 34 from the reservoir 9. When installing the device 10 to a post 36 four foot or less under a deck, where to the device is difficult to reach after the decking planks have been fixed to the structure, the device should be installed during the construction of the deck. A flexible extension tube of the diameter of the inlet opening 14 can be fitted to extend from the inlet opening and half way into a similar size hole drilled into the deck, so the plug 20 can cover the opening of the extension tube..

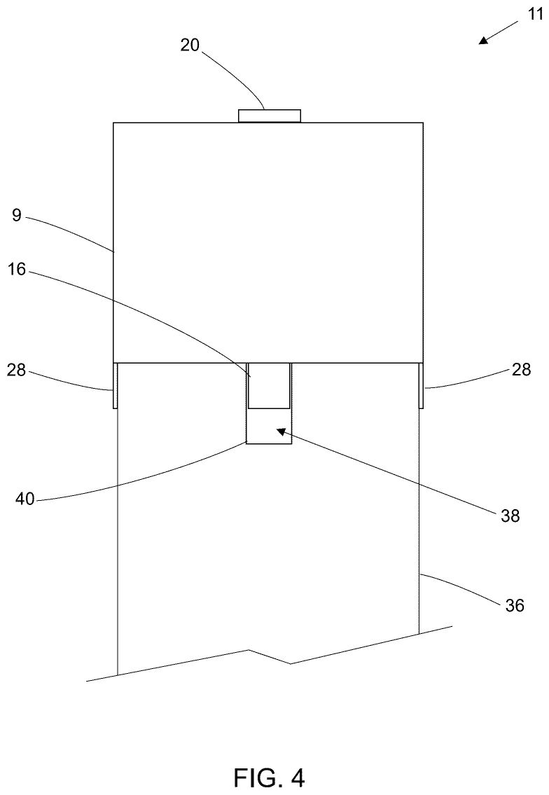

FIG. 4 shows a second embodiment of a device 11 according to the present invention. Not all features of the device 11 are shown in FIG. 4, but features not shown or not described herein, are substantially the same as their counterparts described above with reference to FIGS. 1-3. The same reference signs are used in FIG. 4 to identify features that are common between the device 11 and device 10 shown in FIGS. 1-3, although the features may be shaped or configured somewhat differently. The motivation behind this embodiment of the invention is that the device 11 is fitter to the top of the post 36 as a cap, also allowing oil to gravity feed throughout the post. The concept is that same as shown in FIGS. 1-3, but the device 11 is not designed to save the post from rot at the bottom where it enters the ground-which is the biggest problem area with rot.)

The device 11 is fitted on top of the post 36 and the spout 16 is disposed on a bottom surface of the reservoir 9. The position of the spout 16 in this embodiment is still at a lower elevation than the inlet opening 14, as described above. The installation and operation of the device 11 is identical to that of the device 10, apart from clear differences, such as the absence of a vent aperture in device 11. The device 11 preferably also has a vent aperture and a lip to prevent rain from entering the reservoir, but the vent aperture and lip are not shown in FIG. 4. In most instances, even if the top device 11 has been installed, if the post 36 enters the ground it will also need the unit 10 to preven the rot around ground level.

The foregoing disclosure is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant in the art having the benefit of the present disclosure. Further, the embodiments described are also intended to explain the best mode for carrying out the invention, and to enable others skilled in the art to utilize the invention and such or other embodiments and with various modifications required by the particular applications or uses of the invention. It is intended that the claims based on this disclosure be construed to include alternative embodiments to the extent that is permitted by prior art.

The present invention protects the wood by oiling from the inside out for full penetration of the wood instead of merely brushing oil onto the exterior of the wood, which only penetrates the surface, leaving the core of the wood vunerable to rot—especially at the base of the post 36 where it meets the ground.

What is claimed is:

1. A device for preserving a wood structure, said device comprising:
a reservoir defining an internal cavity and an inlet opening in flow communication with the internal cavity, said reservoir being configured to be used in an upright orientation;
support means for supporting the reservoir adjacent to the wood structure; a discharge conduit extending from the reservoir, said discharge conduit being in flow communication with the internal cavity and being at a lower elevation than the inlet opening when the reservoir is in the upright orientation, at least part of said discharge conduit being receivable in a passage opening of a passage formed in the wood structure, for flow communication between the discharge conduit and the passage opening; and sealing means for sealing between an outer periphery of the discharge conduit and the passage opening.

2. The device according to claim 1, wherein the sealing means is an O-ring or rubber washer.

3. The device according to claim 1, which includes a closure mechanism configured to close the inlet opening selectively.

4. The device according to claim 3, wherein the closure mechanism is a removable plug.

5. The device according to claim 1, which defines a vent aperture in flow communication with the internal cavity, said vent aperture being at a higher elevation than the discharge conduit.

6. The device according to claim 5, which includes an overhang that extends above the vent aperture, when the reservoir is in the upright orientation.

7. The device according to claim 1, which includes a protective liquid in the internal cavity.

8. The device according to claim 7, wherein the protective liquid inside the internal cavity contains oil.

9. A method for preserving a wood structure, said method comprising:
forming a passage inside the wood structure, said passage having a passage opening on an outer surface of the wood structure;
supporting a reservoir adjacent to the wood structure, said reservoir defining an inlet opening, an internal cavity, and a discharge conduit, and said inlet opening, internal cavity and discharge conduit being in fluid communication, said receiving opening being at a higher elevation that the discharge conduit when the reservoir is in an upright orientation;
connecting the discharge conduit of the reservoir to the passage opening formed in the wood structure, for fluid communication between said discharge conduit and passage opening; filling the internal cavity at least in part with the protective liquid, from the inlet opening; and
allowing the protective liquid to flow under gravity from the internal cavity, via the discharge conduit and the passage opening into the passage inside the wood structure allowing the protective liquid to penetrate the wood structure from the passage.

10. The method according to claim 9, which includes allowing the protective liquid to penetrate the wood structure.

11. The method according to claim 9, which includes sealing the connection between the discharge conduit of the reservoir and the passage opening formed in the wood structure.

12. The method according to claim 11, which includes fitting an O-ring or rubber washer around a periphery of the discharge conduit.

13. The method according to claim 9, which includes supporting the reservoir near a base of the wood structure.

14. The method according to claim 9, which includes attaching the reservoir to the wood structure using fasteners.

15. The method according to claim 9, which includes closing the inlet opening selectively with a removable plug.

16. The method according to claim 15, which includes allowing air to escape from the internal cavity through a vent aperture when the inlet opening is closed.
